(19) United States
(12) Patent Application Publication
(10) Pub. No.: US 2003/0026543 A1
(43) Pub. Date: Feb. 6, 2003

(54) Tunable wideband dispersion compensator

(75) Inventors: Veronique Verdrager, Gif-sur-Yvette (FR); Jean-Jacques Guerin, Antony (FR); Isabelle Riant, Orsay (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/207,863

(22) Filed: Jul. 31, 2002

(30) Foreign Application Priority Data
Aug. 6, 2001 (FR) 01 10 498

(51) Int. Cl. G02B 6/34

(52) U.S. Cl. 385/37; 385/27

(57) ABSTRACT

A system for compensating chromatic dispersion includes a long variable pitch Bragg grating written in an optical fiber in which wavelength division multiplexed transmission channels propagate. A system for generating a thermal gradient includes at least two heating systems distributed over the grating and controlled independently of each other to compensate simultaneously the chromatic dispersion on a plurality of transmission channels.

### CROSS-REFERENCE TO RELATED APPLICATIONS

This application is based on French Patent Application No. 01 10 498 filed Aug. 6, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to telecommunications at high bit rates on optical fibers. To be more specific, the invention applies to a photosensitive fiber incorporating a Bragg grating filter specifically adapted to compensate the effects of chromatic dispersion and chromatic dispersion slope in an optical fiber link.

2. Description of the Prior Art

Chromatic dispersion occurs when short pulses propagate over large distances because of progressive dispersion of the group velocities of a pulse as it propagates. FIG. 1 shows the chromatic dispersion slope. The effects of chromatic dispersion are cumulative over the length of the link and are therefore more severe on long links. Chromatic dispersion also causes temporal widening of the pulses routed over the link (chromatic dispersion slope). Accordingly, if the pulses are sufficiently spaced in time, the risk of error on reception is minimized, but on the other hand, in systems using high bit rates, the temporal widening of a pulse can be of the same order of magnitude as the spacing between the pulses, producing an error rate that is unacceptable for the link operator. For example, at around 1.55 μm, the order of magnitude of the temporal widening of a pulse is 17 ps/nm/km. This distortion is because, at around 1.55 μm, “high-frequency” components of the spectrum of the pulse propagate faster than “low-frequency” components, which leads to a redistribution of the spectral components during propagation.

The person skilled in the art knows that variable pitch (“chirped”) Bragg gratings can compensate chromatic dispersion.

FIG. 2 is a block diagram of a chromatic dispersion compensator using a variable pitch Bragg grating. A variable pitch Bragg grating RB is written in the core of the fiber 10 in the conventional way via a phase mask whose pitch varies over the length of the fiber through which the light wave travels to modify the wavelength reflected by the grating along the length of the fiber. Linear variation of the pitch of the grating, and therefore of the reflected wavelength along the fiber, can be used to correct first order chromatic dispersion (which is the phenomenon usually referred to as chromatic dispersion) and a quadratic variation of the pitch can be used to correct the effects of second order chromatic dispersion (usually referred to as chromatic dispersion slope). This is shown in FIG. 2. The variation of the pitch of the grating induces a variable time-delay of reflection of the wave at the grating, which corrects the dispersion. This kind of Bragg grating is generally associated with an optical circulator.

The wavelength division multiplexing (WDM) technique is routinely employed on optical links using high bit rates. In the WDM technique, a wideband light source is coupled to means for separating discrete wavelengths and a number of channels simultaneously launch signals at a given wavelength into the link optical fiber. The effects of chromatic dispersion are therefore duplicated for each wavelength on each channel. Compensating first and second order chromatic dispersion over a wide band, i.e. on a plurality of wavelength division multiplexed channels, necessitates either concatenating Bragg gratings, each of which compensates a portion of the dispersion for a given portion of the spectral band, or producing a very long chirped Bragg grating. A long Bragg grating is described in OFC'01, PD12, 2001, J. F. Brennan, E. Hernandez, J. A. Valenti, P. G. Sinha, M. R. Matthews, D. E. Elder, G. A. Beauchesne and C. H. Byrd: “Dispersion and dispersion-slope correction with a fiber Bragg grating over the full C-band”.

Another problem that may be encountered by optical link operators is the evolution of chromatic dispersion over time, due to climatic variations or aging of the optical link, for example.

This evolution of chromatic dispersion over time necessitates adaptation of the transmission network and in particular of the dispersion compensators used. An optical link typically comprises optical fiber sections that connect stations or repeaters in which the optical signals to be propagated are amplified before being transmitted to the next section. It is generally necessary to provide the link with regularly spaced chromatic dispersion compensators. It is not feasible to change the dispersion compensators in the event of a climatic change or when the optical link or the components constituting it age.

There exist prior art dispersion compensators which can be tuned, i.e. whose characteristics can be modified by remote control so that the same compensator can be used for wavelengths that vary.

The person skilled in the art knows that mechanical and/or thermal action on an optical fiber portion modifies the properties of the grating written optically therein. In particular, the pitch of the grating can be varied mechanically or thermally. U.S. Pat. No. 5,671,307 proposes writing a Bragg grating in an optical fiber portion and imposing a variation of the pitch of the grating by applying a thermal gradient distributed over the grating. The Bragg grating is not written directly with a chirp, i.e. with a variable pitch, but the thermal gradient imposes a variation of the pitch on the grating according to the wavelength to be reflected. The technique proposed in the above patent is therefore applicable to only one channel for only one tunable wavelength.

In addition, OFC'99, 20/FA7-1, J. X. Cai, K. M. Feng, A. E. Willner, V. Grubsky, D. S. Starodubov and J. Feinberg: “Sample nonlinearly-chirped fiber-Bragg-grating for the tunable dispersion compensation of many WDM channels simultaneously” proposes (by stretching it) applying a mechanical stress to a fiber portion incorporating a chirped Bragg grating. The wavelengths reflected can therefore be tuned as a function of the location and the magnitude of the mechanical stress applied to the grating. This solution is limited to three wavelength channels, however. However, one example of a 25 GHz wavelength division multiplexed transmission network includes 160 channels in the C band.

The present invention proposes to provide for each channel of a dense wavelength division multiplex (DWDM) network a chromatic dispersion compensator that can be tuned. The invention provides a single component to fulfil the dispersion compensator function simultaneously for a plurality of transmission channels of a WDM system.

To this end, the invention proposes to apply a thermal gradient to a variable pitch Bragg grating to tune the reflectivity for each transmitted wavelength in order to compensate first and/or second order chromatic dispersion on all transmission channels.

### SUMMARY OF THE INVENTION

To be more specific, the invention provides a system for compensating chromatic dispersion, including a long variable pitch Bragg grating written in an optical fiber (10) in which wavelength division multiplexed transmission channels propagate, and means for generating a thermal gradient including at least two heating systems (20) distributed over the grating and controlled independently of each other to compensate simultaneously the chromatic dispersion on a plurality of the transmission channels.

In the embodiments, the heating systems comprise a thermal film or Peltier elements.

According to one feature the optical fiber is placed in a groove that conducts heat.

Depending on the application, the thermal gradient has a linear distribution or a quadratic distribution.

In a different embodiment the thermal gradient features a constant temperature at a point of said grating corresponding to a position at which a central wavelength of at least one transmission channel is reflected.

In the embodiments the Bragg grating has a continuous pitch variation or a discontinuous pitch variation.

According to one feature the heating systems are controlled dynamically.

The features and advantages of the present invention will emerge more clearly on reading the following description, which is given by way of illustrative and non-limiting example only and with reference to the accompanying drawings.

### BRIEF DESCRIPTION OF THE DRAWINGS

FIG. 1, already described, shows a chromatic dispersion slope to be corrected.

FIG. 2, already described, is a block diagram of a chromatic dispersion compensator.

FIG. 3 shows a chromatic dispersion compensator according to the invention.

FIG. 4 is a graph showing the variation in the pitch of a Bragg grating as a function of thermal distribution in one particular application of the invention.

FIGS. 5 and 6 are graphs showing the wavelength reflected along the Bragg grating as a function of the thermal distribution, respectively for a linear grating and for a discontinuous grating.

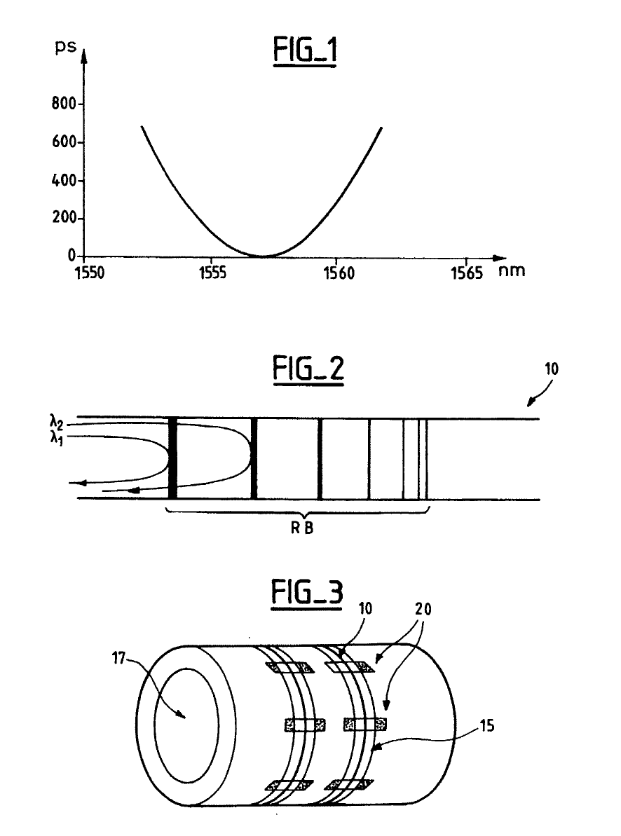

### DETAILED DESCRIPTION OF THE PREFERRED EMBODIMENT

Bragg gratings are governed by the following Bragg equation, in which n_{eff} is the effective index of the guided mode and Λ is the pitch of the grating:

λ_{B}=2n_{eff}Λ

This equation shows that the Bragg wavelength Λ_{B} is sensitive to modifications of the effective index, which means that the reflection wavelength can be tuned by action on the fiber at the level of the Bragg grating. For example, localized heating of the fiber locally modifies n_{eff} and thereby modifies Λ_{B}.

Referring to FIG. 3, the invention proposes to subject an optical fiber 10 comprising a long chirped Bragg grating to a temperature gradient distributed over the grating. A long variable pitch grating compensates chromatic dispersion by the prior art mechanism previously described. Furthermore, the temperature gradient generates a temperature distribution over the whole of the Bragg grating and thereby tunes the wavelengths reflected along the grating.

The temperature gradient is generated by at least two separate and independently controlled heating systems 20. In order to obtain any required temperature distribution, a plurality of heating systems 20 is preferably distributed regularly over the whole of the fiber portion comprising the Bragg grating. The temperature distribution can be linear or quadratic to correct first order chromatic dispersion or chromatic dispersion slope.

In an advantageous embodiment, the optical fiber 10 is placed in a groove formed in a ribbon 15 made from a material that conducts heat and the ribbon 15 is wound around a cylinder 17 made from a material that does not conduct heat, for example. The heating systems 20 can be Peltier elements known to the person skilled in the art or a thermal film covering the fiber 10. Peltier heating systems can typically produce a temperature variation from 0° C. to 60° C. The heating systems 20 are controlled by dynamic tuning means that are not shown but will be evident to the person skilled in the art.

The thermal sensitivity of the pitch of a Bragg grating is given by the following theoretical equation:

dΛ/dT=10 pm/° C.

Thus, if ΔΛ₀ is the initial pitch variation of the chirped grating and ΔT is the linear temperature gradient between the two ends of the Bragg grating, then the resultant variation in the pitch, in nanometers, is given by the equation:

ΔΛ=ΔΛ₀+0.01ΔT

Because the dispersion is related to the pitch of the grating, a variation of said pitch induces a modification D of the chromatic dispersion in accordance with the following approximate equation, in which L is the length of the Bragg grating:

D=10L/ΔΛ

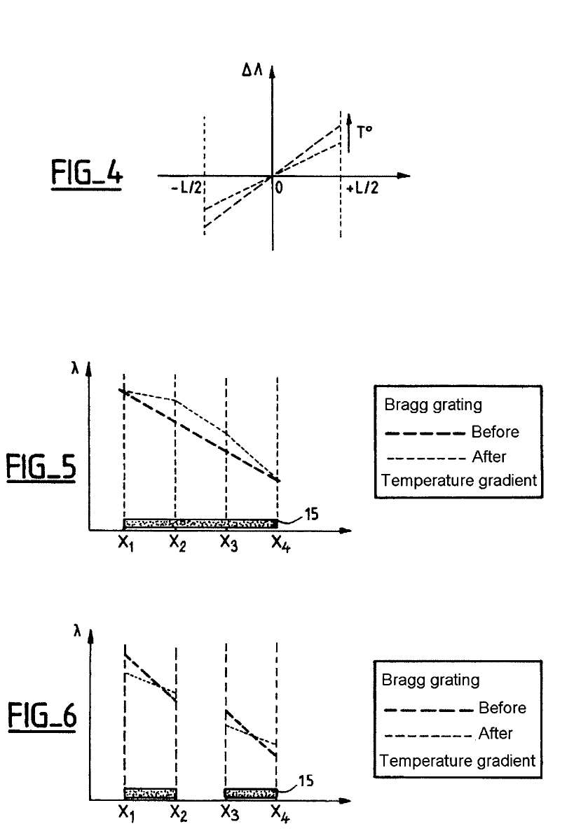

In one particular embodiment, to which the FIG. 4 graph refers, the temperature can remain constant at a given point of the Bragg grating, at which the central transmission wavelength is reflected, and vary linearly on either side of this point, to prevent spectral shifting of all the wavelengths.

The FIGS. 5 and 6 graphs show particular embodiments of the invention in the case of a continuous variable pitch Bragg grating and in the case of a discontinuous variable Bragg grating, respectively. The points Xᵢ represent the locations of the heating systems 20 along the fiber placed on the material 15 that conducts heat. A linear temperature gradient is produced between two successive points Xᵢ and Xᵢ₊₁ in particular because of the material 15 that conducts heat on which the optical fiber is placed.

FIG. 5 shows that controlling the heating points Xᵢ independently can induce any modification of a reflection wavelength λ at any point of the grating.

In one embodiment, the chirped Bragg grating can be written into the fiber in a discontinuous manner. Heating systems are then disposed at each end of each grating portion. The thermal distribution between X₁ and X₂ is totally independent of the thermal distribution between X₃ and X₄, enabling the dispersion to be tuned for each transmission channel independently of the others.

There is claimed:

1. A system for compensating chromatic dispersion, including a long variable pitch Bragg grating written in an optical fiber in which wavelength division multiplexed transmission channels propagate, and means for generating a thermal gradient including at least two heating systems distributed over said grating and controlled independently of each other to compensate simultaneously the chromatic dispersion on a plurality of said transmission channels.

2. The chromatic dispersion compensating system claimed in claim 1 wherein said heating systems comprise a thermal film.

3. The chromatic dispersion compensating system claimed in claim 1 wherein said heating systems comprise Peltier elements.

4. The chromatic dispersion compensating system claimed in claim 1 wherein said optical fiber is placed on a material that conducts heat.

5. The chromatic dispersion compensating system claimed in claim 1 wherein said thermal gradient has a linear distribution.

6. The chromatic dispersion compensating system claimed in claim 1 wherein said thermal gradient has a quadratic distribution.

7. The chromatic dispersion compensating system claimed in claim 1 wherein said thermal gradient features a constant temperature at a point of said grating corresponding to a position at which a central wavelength of at least one transmission channel is reflected.

8. The chromatic dispersion compensating system claimed in claim 1 wherein said Bragg grating has a continuous pitch variation.

9. The chromatic dispersion compensating system claimed in claim 1 wherein said Bragg grating has a discontinuous pitch variation.

10. The chromatic dispersion compensating system claimed in claim 1 wherein said heating systems are controlled dynamically.
